(19) United States
(12) Patent Application Publication
(10) Pub. No.: US 2011/0283674 A1
(43) Pub. Date: Nov. 24, 2011

(54) ROTARY MOWER CONFIGURED TO RETARD VEGETATION FLOW

(75) Inventor: Cam Wilson, Vonda (CA)

(73) Assignee: HIGHLINE MANUFACTURING INC., St. Brieux (CA)

(21) Appl. No.: 13/072,065

(22) Filed: Mar. 25, 2011

(30) Foreign Application Priority Data
May 20, 2010 (CA) 2,704,908

(51) Int. Cl. A01D 34/73

(52) U.S. Cl. 56/255

(57) ABSTRACT

A rotary mower apparatus includes a mower deck with a top side and an underside. A blade assembly is mounted below the underside of the mower deck, and includes blade members at outer portions thereof. A drive is operative to rotate the blade assembly such that the blade members move in a circular path under the underside of the mower deck. A plurality of elongate retarding members extend downward from the underside of the mower deck, and each retarding member extends transverse to the circular path of the blade members and transverse to a flow path of cut vegetation.

### FIELD OF THE INVENTION

This invention is in the field of rotary mowers and in particular a rotary mower with the underside of the deck configured to retard the movement of material with respect to the deck underside to retain material under the deck to improve the quality of the cut.

### BACKGROUND

Rotary mowers comprise generally a mower deck, a rotating blade assembly under the deck, and a driveline connecting the blade assembly to a rotating power source, typically the power take off of a tractor to which the mower is mounted or connected by a hitch for towing.

The mower deck comprises a frame that provides the skeleton of the deck. Brackets, hitches, and the like for mounting or towing the mower are attached to a front member the frame, and wheels may be mounted to the frame at various locations to support the deck for travel along the ground. The driveline typically includes a gear box or a hydraulic motor mounted on top of a central frame member, and a shaft extending downward through the center of the deck. The blade assembly is then mounted to the shaft under the deck.

A skin of relatively thin metal covers the frame and provides the finished top side of the deck, and generally extends downward along the sides of the deck. The skin encloses the blade assembly and confines the vegetation being cut under the deck and typically directs the cut vegetation out under the rear of the deck. Typically the vegetation is contacted by blades multiple times before being discharged from the mower, and thus is cut into small pieces in a finer cut, as is generally desired. The finer the cut the better, where a finer cut is interpreted to mean a cut where the pieces of cut vegetation being discharged from the mower are smaller than when the cut is coarser.

Rotary mowers are used in a wide variety of applications in a variety of conditions which vary with the density, height, moisture, content etc. of the vegetation. These mowers then must be designed to operate in all these various conditions as it is not possible to tell what conditions an end user may encounter. Thus the underside of the deck above the blades is kept smooth so that the cut vegetation can freely flow out from under the deck.

Wet or moist vegetation has a tendency to stick and build up under the deck, requiring periodic cleaning if the mower is subjected to lengthy continued use in moist vegetation.

Considerable work has been done with smaller rotary mowers such as are used for lawn mowing. U.S. Pat. No. 7,665,286 to Butler et al. discloses a mulch deck having a system of one or more baffles to facilitate the reduction of grass clippings into tiny particles of mulch. The baffles are curved under the deck and generally follow the curved path of the mower blade. The baffles somewhat retard the flow of lawn grass so that it is contacted more often by the blade and is cut finer, and the baffles are also configured to direct the lawn clippings along the curved path of the blade and out through a chute.

In United States Patent Application Number 20080047249 of Davis, air flow through a volute section is dependent on the position of a baffle and provides a means for controlling the volute width and air flow through side discharge opening of the mower in order to optimize operating characteristics of the mower depending on local turf conditions.

In United States Patent Application Number 20060230735 of Samejima, a plurality of baffles under a triple blade side discharge deck retard the flow of material for a finer cut, and also direct cut material from the blades farther from the discharge across the deck to the discharge opening which can be adjusted to be larger or smaller.

The prior art in these lawn mowing machines is directed to simultaneously retarding the grass clippings to improve the cut, and also guiding the grass clippings out through a discharge chute or the like. The retarding of flow can be facilitated by controlling the size of the discharge opening.

In the lawn mower disclosed in U.S. Pat. No. 6,062,013 to Wolske, grass and leaves are cut using a standard cutting blade and then the mass of cut vegetation is then lifted upward into a hammermill by the trailing edge of the rotating cutting blade.

A large rotary mower disclosed in U.S. Pat. No. 5,673,545 to Friesen increases the fineness of cut by providing a plurality of blades spinning at different heights under the mower. Also discussed is the use of stationary blades fixed to the underside of the mower deck so that the spinning blades pass fairly closely under or over the fixed blades and so the spinning blades push vegetation against the fixed blades.

### SUMMARY OF THE INVENTION

It is an object of the present invention to provide a rotary mower apparatus that overcomes problems in the prior art.

The present invention provides a rotary mower apparatus comprising a mower deck with a top side and an underside. A blade assembly is mounted to the mower deck below the underside of the mower deck, and the blade assembly comprises blade members at outer portions of the blade assembly. A drive is mounted to the mower deck and is operative to rotate the blade assembly such that the blade members move in a circular path under the underside of the mower deck. A plurality of elongate retarding members extend downward from the underside of the mower deck, and each retarding member extends transverse to the circular path of the blade members and transverse to a flow path of cut vegetation.

The retarding members retard the flow of cut vegetation such that the vegetation is retained under the mower deck for an increased period of time, and is thus contacted by the blade members an increased number of times, and so is cut into smaller pieces, increasing the fineness of the cut. The invention is suited for operation in relatively dry vegetation, such as dead plants and stalks.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a bottom view of an embodiment of a rotary mower apparatus of the present invention;

FIGS. 2A-2C schematically illustrate a variety of cross-sectional shapes of retarding members for use with the embodiment of FIG. 1;

FIG. 3 is a schematic bottom view of an embodiment of a rotary mower apparatus of the present invention where instead of having a smooth underside as in the embodiment of FIG. 1, the underside of the mower deck is defined by a plurality of frame members and a bottom surface of a skin laid over the frame members;

FIG. 4 is a schematic side view of the embodiment of FIG. 3;

FIG. 5 is a bottom side perspective view of an embodiment of a rotary mower apparatus of the present invention where the mower deck includes a blade ring extending down from the underside thereof;

FIG. 6 is a schematic bottom view of the embodiment of FIG. 5 including retarding members extending inward and outward from the blade ring;

FIG. 7 is a schematic side view showing the attachment of the retarding members to the blade ring in the embodiment of FIG. 5;

FIG. 8 shows an alternate arrangement of the underside of the deck, the blade ring, and the retarding members.

### DETAILED DESCRIPTION OF THE ILLUSTRATED EMBODIMENTS

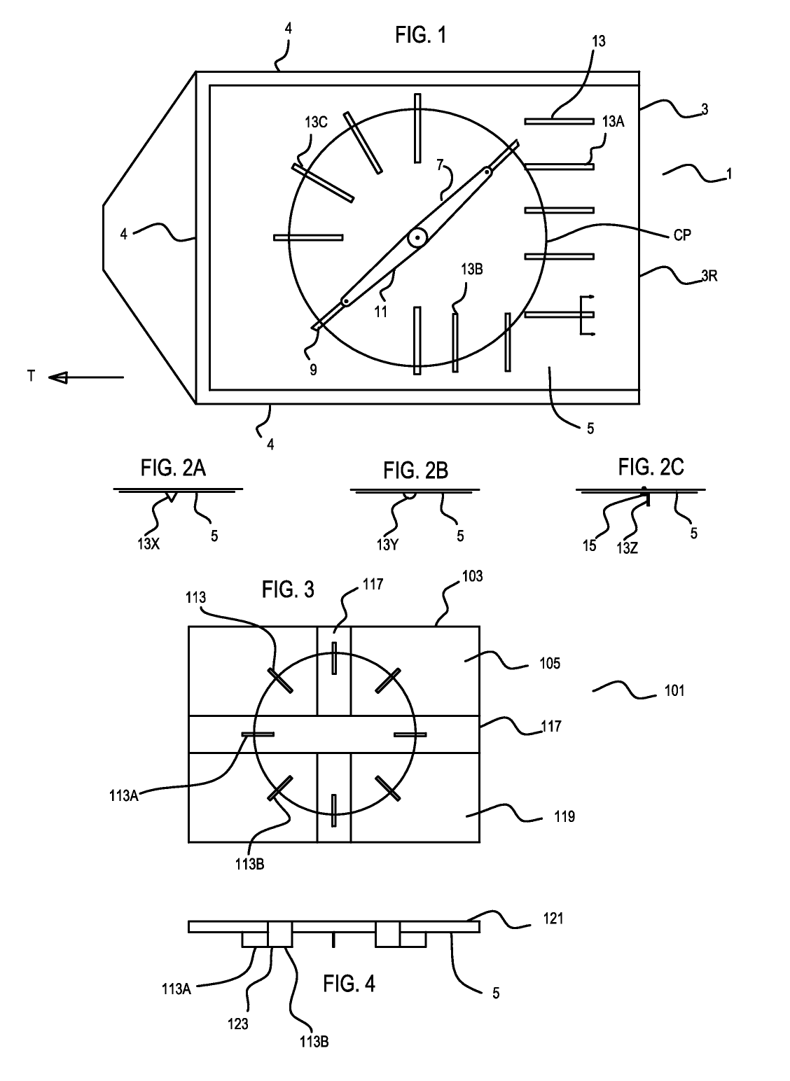

FIG. 1 illustrates an embodiment of a rotary mower apparatus 1 of the present invention. The apparatus 1 comprises a mower deck 3 with a top side and an underside 5. The top side is not visible but is opposite the illustrated underside. A blade assembly 7 is mounted to the mower deck 3 below the underside 5 of the mower deck 3. The blade assembly 7 comprises blade members 9 at outer portions of the blade assembly 7. In the illustrated apparatus 1, the blade members 9 are pivotally attached to blade arms 11. A drive is mounted to the mower deck 3 on the top side thereof and so is not visible. The drive is operative to rotate the blade assembly 7 such that the blade members 9 move in a circular path CP under the underside 5 of the mower deck 3. Vegetation cut by the blade members 9 and generally confined by front and side panels 4 is forced by the rotating blade members 9 into a flow path substantially tangential to the circular path CP under the mower deck and is thrown out the open rear end 3R of the mower deck 3.

A plurality of elongate retarding members 13 are mounted below the underside 5 of the mower deck 3. Each retarding member 13 extends transverse to the circular path CP of the blade members 9 and transverse to the flow path of cut vegetation. Thus instead of cut vegetation flowing smoothly along the underside 5 of the mower deck 3, the flow of cut vegetation is retarded by the retarding members 13 extending downward from the underside 5 of the mower deck 3, such that the vegetation is retained under the mower deck for an increased period of time, and is thus contacted by the blade members 9 an increased number of times, and so is cut into smaller pieces, increasing the fineness of the cut.

While the apparatus works very well to increase the fineness of the cut in dry vegetation, its use is somewhat limited because when vegetation is wet, it tends to stick to the retarding members 13, and can greatly increase power requirements and reduce the effectiveness of the mowing operation.

The retarding members can be positioned in a variety of orientations, as illustrated in FIG. 1, and still achieve the retarding action needed to increase the fineness of cut. Basically the retarding members 13 are oriented transverse to, or generally across, the circular path

CP of the blade members 9 so that the flow of cut vegetation tangential to that path is retarded. Retarding members 13A are oriented in alignment with the operating travel direction T, while retarding members 13B are oriented substantially perpendicular to the operating travel direction T. Both retarding members 13A, 13B are positioned on the underside 5 of the mower deck 3 so that they are transverse to the circular path CP.

Retarding members 13C are positioned such that they extend substantially radially with respect to the circular path CP, and are substantially equally spaced along the circular path CP. This configuration has the advantage that the degree of retardation of the vegetation flow is substantially equal around the circular path CP.

The retarding members 13 can take a variety of shapes as well and still perform the retarding function. FIG. 2A illustrates a retarding member 13X that has a triangular cross section. FIG. 2B illustrates a retarding member 13Y that has a semicircular cross section. FIG. 2C illustrates a retarding member 13Z that has a rectangular cross section.

While the retarding members 13 can be attached to the underside 5 by welding or the like, it may also be desirable to make the retarding members 13 removable. For example in FIG. 2C the retarding member 13Z is attached to the underside 5 by a removable bolt 15.

In the apparatus 1 of FIG. 1, the underside of the mower deck 3 is substantially a smooth plate of steel or the like, such as is found where a lower skin has been attached under the frame of the mower deck 3.

As schematically illustrated in the alternate embodiment of the rotary mower apparatus 101 of FIGS. 3 and 4, often the underside 105 of the mower deck 103 is defined by a plurality of frame members 117 and a bottom surface 119 of a skin 121 laid over top of the frame members 117 and is therefore not a smooth surface as in the apparatus 1 of FIG. 1. In this common situation, the retarding members 113 can be configured such that bottom edges 123 of the retarding members 113A mounted on the frame members 117 are substantially at the same vertical level as those retarding members 113B mounted directly on the bottom surface 119 of the skin 121, as seen in FIG. 4, to provide even retardation of vegetation flow.

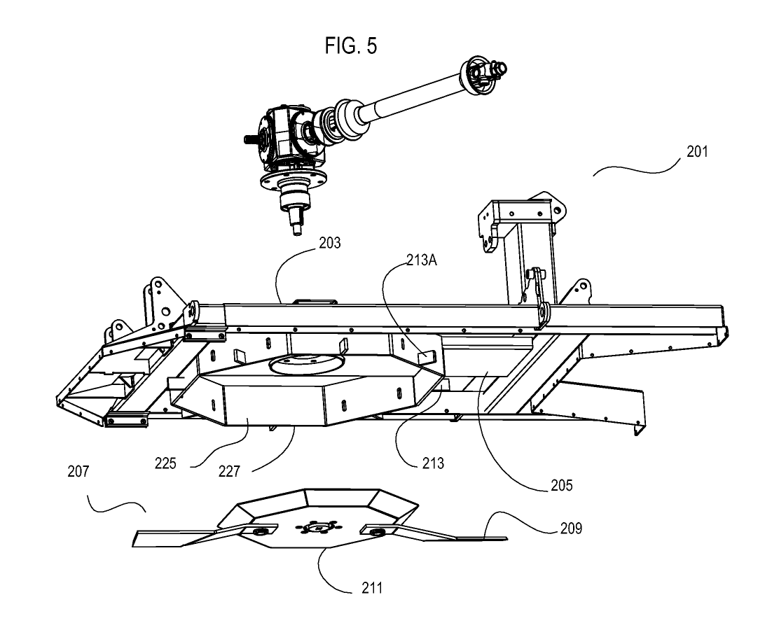

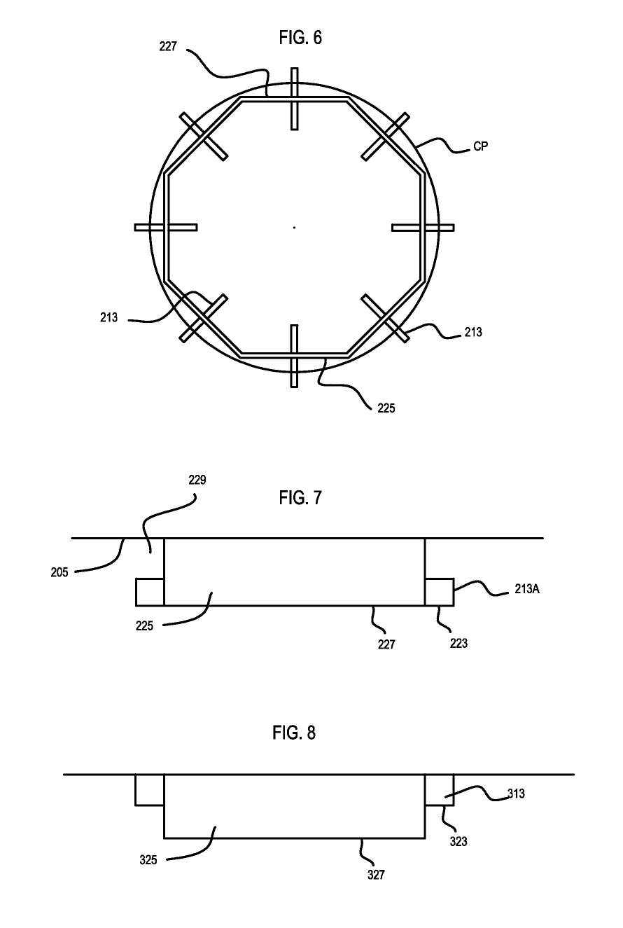

FIGS. 5 and 6 illustrate an alternate embodiment of the rotary mower apparatus 201 where the underside 205 of the mower deck 203 has a blade ring 225 extending downward from the underside 205 and configured such that a bottom edge 227 of the blade ring 225 is located above and in proximity to the circular path CP of the blade members 209. In the exploded view of the apparatus 201 in FIG. 5, the drive is shown, and also the blade assembly 207 is of the known type where the blade members 209 are pivotally attached to a blade pan 211.

In the apparatus 201, the retarding members 213 are attached to the blade ring 225. In FIGS. 5 and 7, the retarding members 213A extend outward from the blade ring 225, and are attached near the bottom edge of the blade ring 225 such that the bottom edges 223 of the retarding members 213A are located at substantially the same vertical position as the bottom edge 227 of the blade ring 225. The illustrated retarding members 213A are attached only at ends thereof to the blade ring 225, such that there is a gap 229 between a top edge of the retarding members 213A and the underside 205 of the deck.

FIG. 8 illustrates an alternate arrangement where the bottom edges 323 of the retarding members 313 are above the bottom edge 327 of the blade ring 325. FIG. 6 shows the retarding members 213 extending both inward and outward from the blade ring 225.

The present invention provides a finer cut in dry vegetation than is possible with similar mowers of the prior art.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A rotary mower apparatus comprising:
a mower deck with a top side and an underside;
a blade assembly mounted to the mower deck below the underside of the mower deck, the blade assembly comprising blade members at outer portions of the blade assembly;
a drive mounted to the mower deck and operative to rotate the blade assembly such that the blade members move in a circular path under the underside of the mower deck; and
a plurality of elongate retarding members mounted below the underside of the mower deck, each retarding member extending transverse to the circular path of the blade members and transverse to a flow path of cut vegetation.

2. The apparatus of claim 1 wherein the retarding members are substantially equally spaced along the circular path.

3. The apparatus of any one of claims 1 and 2 claim 1 wherein the retarding members extend substantially radially with respect to the circular path.

4. The apparatus of claim 1 wherein the underside of the mower deck is defined by a plurality of frame members and a bottom surface of a skin laid over the frame members, and wherein the retarding members are configured such that bottom edges of the retarding members are substantially at the same vertical level.

5. The apparatus of claim 1 wherein the mower deck includes front and side panels extending down ward from the top side of the mower deck, and an open rear end, such that vegetation cut by the blade members is confined under the mower deck by the panels and is forced by the rotating blade members into the flow path, and the flow path is substantially tangential to the circular path of the blade members and such that the cut vegetation is thrown out the open rear end of the mower deck.

6. The apparatus of claim 1 further comprising a blade ring extending downward from the underside of the mower deck and configured such that a bottom edge of the blade ring is located above and in proximity to the circular path of the blade members, and wherein the retarding members are attached to the blade ring.

7. The apparatus of claim 6 wherein there is a gap between a top edge of at least one retarding member and the underside of the deck.

8. The apparatus of claim 6 wherein a bottom edge of at least one retarding member is above the bottom edge of the blade ring.

7. : ROTARY MOWER CONFIGURED TO RETARD VEGETATION FLOW

9. The apparatus of claim 6 wherein at least one retarding member extends outward from the blade ring.

10. The apparatus of claim 6 wherein at least one retarding member extends inward from the blade ring.

11. The apparatus of claim 6 wherein a bottom edge of at least one retarding member is located at substantially the same vertical position as the bottom edge of the blade ring.

12. The apparatus of claim 1 wherein the retarding members are removable.
